(19) United States
(12) Patent Application Publication
(10) Pub. No.: US 2009/0081352 A1
(43) Pub. Date: Mar. 26, 2009

(54) OIL/ FAT COMPOSITION

(75) Inventors: Yoshiyuki Hatano, Yokosuka-shi (JP); Akira Akahane, Yokosuka-shi (JP); Yumiko Moriya, Yokohama-shi (JP); Hiroko Nakahara, Yokohama-shi (JP); Hirofumi Haruna, Yokohama-shi (JP)

Correspondence Address: WOOD, HERRON & EVANS, LLP, 2700 CAREW TOWER, 441 VINE STREET, CINCINNATI, OH, 45202, US

(73) Assignee: THE NISSHIN OILLIO GROUP, LTD., Tokyo (JP)

(21) Appl. No.: 11/913,864

(22) PCT Filed: Apr. 26, 2006
(86) PCT No.: PCT/JP2006/308753

§ 371 Date: Nov. 8, 2007

(30) Foreign Application Priority Data
May 11, 2005 (JP) 2005-138687

(51) Int. Cl. A23D 7/00

(52) U.S. Cl. 426/607

(57) ABSTRACT

An oil/fat composition including an oil/fat which is in a fluid state at 30° C.; solid fat derived from palm oil and which has an iodine value of 0 to 21; and highly hydrogenated oil of high erucic rapeseed oil; wherein a solid fat content of the oil/fat, which is in a fluid state at 30° C., at 10° C. is 0 to 30% and also the solid fat content thereof at 25° C. is 0 to 15%.

### TECHNICAL FIELD

The present invention relates to an oil/fat composition for a spread and shortening used for kneading, spread and shortening used for kneading which use said oil/fat composition, and production method of said spread and shortening used for kneading.

Priority is claimed on Japanese Patent Applications No. 2005-138687, filed May 11, 2005, the content of which is incorporated herein by reference.

### BACKGROUND ART

Oil/fat compositions which are used as a body oil of a spread such as soft chocolate that is spread on a loaf of bread are used in order to give a spread such as soft chocolate plasticity, excellent melt-in-the-mouth characteristics, and the like. In addition, the shortening used for kneading, which has the aforementioned oil/fat composition as a main component and contains no water is used as a material for bread, biscuits, or the like to provide them with a pleasant taste, fragility, or the like.

These spreads and shortenings used for kneading are required to have plasticity and also at the same time, not to be separated into solid- and liquid oil/fat (hereinafter, the phenomenon is referred to as solid/liquid separation) over a wide temperature range. In addition, spreads are required to have favorable melt-in-the-mouth characteristics. Conventionally, it has been general to carry out rapid-cooling/mixing (rapid-cooling/kneading) at the time of producing oil/fat compositions and spreads and shortenings used for kneading which use said oil/fat compositions in order to provide them with plasticity.

Regarding oil/fat compositions and spreads or shortenings used for kneading using said oil/fat compositions, quality improvements and streamlining of the production process such as provision of plasticity and suppression of solid/liquid separation over a wide temperature range, and furthermore, the omission of rapid-cooling/mixing in the production process thereof have been studied conventionally. For example, the following and the like are proposed as known art: a spread having an oil/fat, which is in a liquid state at normal temperature, and trisaturated fatty acid triglyceride, which contains behenic acid, as essential components (refer to Patent Document 1); an oil/fat which is for kneading into bread and which has palm oil/fat and highly hydrogenated oil of palm oil/fat as essential components (refer to Patent Document 2); an oil/fat composition having plasticity which has an oil/fat that is in a liquid state at 25° C., highly hydrogenated oil having a melting point of 55° C. or more, and triacylglycerol as essential components (refer to Patent Document 3); or peanut butter containing medium chain fatty acid triglyceride, highly hydrogenated oil of soybean oil, and highly hydrogenated oil of rapeseed oil (refer to Patent Document 4).

### [Patent Document 1] Japanese Laid-Open Patent Application No. 2004-290035

### [Patent Document 2] Japanese Laid-Open Patent Application No. 2004-121114

### [Patent Document 3] Japanese Laid-Open Patent Application No. 2004-204067

[Patent Document 4] Japanese Unexamined Patent Application, First Publication No. Hei 2-131557

### DISCLOSURE OF THE INVENTION

### Problems to be Solved by the Invention

However, although a spread having satisfactory plasticity without carrying out rapid-cooling/mixing and which has favorable melt-in-the-mouth characteristics is obtained with the invention described in Patent Document 1, the spread has a problem of an unsatisfactory suppression effect of solid/liquid separation in the high temperature range.

On the other hand, with the invention described in Patent Document 2, an oil/fat, which is for kneading into bread, having satisfactory plasticity without carrying out rapid-cooling/mixing is obtained. Furthermore, bread dough having favorable workability and bread with a favorable texture are obtained. However, an unsatisfactory suppression effect of solid/liquid separation in the high temperature range is a problem.

Moreover, although a plastic oil/fat composition having satisfactory plasticity is obtained with the invention described in Patent Document 3, this is due to the carrying out of rapid-cooling/mixing in the production process thereof, and thus it is impossible to streamline the production process, which is a problem.

Furthermore, a rapid-cooling treatment has also been carried out in the peanut butter production process of the invention described in Patent Document 4, and thus, a cumbersome process is a problem.

Accordingly, the object of the present invention is as follows: provision of an oil/fat composition which does not exhibit solid/liquid separation and has satisfactory plasticity and favorable melt-in-the-mouth characteristics over a wide temperature range and in which rapid-cooling/mixing is not required in the production process thereof, provision of a spread with favorable melt-in-the-mouth characteristics and shortening used for kneading, which can produce bread, confectionery, or the like having a favorable texture, using said oil/fat composition; and provision of a production method of such a spread and shortening used for kneading.

### Means for Solving the Problem

As a result of intensive studies, the present inventors discovered that the use of an oil/fat composition having the following as essential components solves the above problem to complete the present invention. They are, an oil/fat which is in a fluid state at 30° C., solid fat derived from palm oil such as highly hydrogenated oil of palm oil and palm stearin which has an iodine value of 0 to 21, and highly hydrogenated oil of high erucic rapeseed oil.

In other words, the aspects of the present invention in order to solve the above problems are as follows.

A first aspect of the present invention is an oil/fat composition containing an oil/fat which is in a fluid state at 30° C., solid fat derived from palm oil and which has an iodine value of 0 to 21, and highly hydrogenated oil of high erucic rapeseed oil, and in which the solid fat content of the aforementioned oil/fat, which is in a fluid state at 30° C., at 10° C. is 0 to 30% and also the solid fat content thereof at 25° C. is 0 to 15%.

A second aspect of the present invention is an oil/fat composition according to the first aspect containing 75 to 99 mass % of the aforementioned oil/fat which is in a fluid state at 30° C., 0.2 to 20 mass % of the aforementioned solid fat derived from palm oil and which has an iodine value of 0 to 21, and 0.2 to 20 mass % of the aforementioned highly hydrogenated oil of high erucic rapeseed oil, and in which the mass ratio between the solid fat derived from palm oil and which has an iodine value of 0 to 21 and highly hydrogenated oil of high erucic rapeseed oil is 95:5 to 20:80.

A third aspect of the present invention is an oil/fat composition according to the first or second aspect where the oil/fat, which is in a fluid state at 30° C., is a medium chain fatty acid triglyceride having a C₆₋₁₀ fatty acid residue.

A fourth aspect of the present invention is an oil/fat composition according to the first or second aspect where the oil/fat, which is in a fluid state at 30° C., is a transesterification oil between liquid oil and solid fat.

A fifth aspect of the present invention is an oil/fat composition according to the fourth aspect in which the solid fat is one, two, or more oils selected from the group consisting of palm oil, fractionated oil of palm oil, highly hydrogenated oil of palm oil, and highly hydrogenated oil of liquid oil.

A sixth aspect of the present invention is an oil/fat composition according to the first or second aspect in which the aforementioned oil/fat which is in a fluid state at 30° C. is a mixed oil of soybean oil, palm olein, and hydrogenated oil of palm oil.

A seventh aspect of the present invention is an oil/fat composition according to any one of the first to sixth aspects in which the aforementioned solid fat derived from palm oil and which has an iodine value of 0 to 21 is highly hydrogenated oil of palm oil or palm stearin.

An eighth aspect of the present invention is a production method of an oil/fat composition in which the composition is obtained by dissolving/mixing an oil/fat which is in a fluid state at 30° C. and the solid fat content thereof at 10° C. is 0 to 30% and solid fat content thereof at 25° C. is 0 to 15%; solid fat derived from palm oil and which has an iodine value of 0 to 21; and highly hydrogenated oil of high erucic rapeseed oil; without carrying out rapid-cooling/mixing.

A ninth aspect of the present invention is a spread using an oil/fat composition according to any one of the first to seventh aspects.

A tenth aspect of the present invention is a spread in a cup- or a tube container which includes the spread according to the ninth aspect and a cup- or a tube container.

An eleventh aspect of the present invention is a shortening used for kneading using the oil/fat composition according to any one of the first to seventh aspects.

A twelfth aspect of the present invention is a shortening used for kneading in a pillow packaging which includes the shortening used for kneading according to the eleventh aspect and a pillow packaging.

A thirteenth aspect of the present invention is a loaf of bread using the shortening used for kneading according to the eleventh or twelfth aspect.

A fourteenth aspect of the present invention is a confectionery using the shortening used for kneading according to the eleventh or twelfth aspect.

A fifteenth aspect of the present invention is a production method of a spread in which the spread is produced by using the oil/fat composition according to any one of the first to seventh aspects without carrying out rapid-cooling/mixing.

A sixteenth aspect of the present invention is a production method of a shortening used for kneading in which the shortening is produced by using the oil/fat composition according to any one of the first to seventh aspects without carrying out rapid-cooling/mixing.

### EFFECTS OF THE INVENTION

According to the present invention, the oil/fat composition which has satisfactory plasticity over a wide temperature range and also at the same time is suppressed from solid/liquid separation is obtained. Moreover, a spread having favorable melt-in-the-mouth characteristics and shortening used for kneading, which is for producing confectionery, bread, or the like, can be obtained by using said oil/fat composition. Furthermore, it is possible to obtain various food products such as bread and confectionery which have an excellent texture by using these spreads or shortenings used for kneading.

In addition, in the production of the aforementioned oil/fat composition, spread, and shortening used for kneading, there is no need to carry out rapid-cooling/mixing, and thus the production process can be simplified and at the same time, production cost can be kept low.

### BEST MODES FOR CARRYING OUT THE INVENTION

The present invention will be described in detail below.

Examples of the oil/fat, which is in a fluid state at 30° C. and is used in the present invention, include liquid oils such as medium chain fatty acid triglyceride having a C₆₋₁₀ fatty acid residue, soybean oil, rapeseed oil, corn oil, safflower oil, sunflower oil, cottonseed oil, olive oil, and Canola oil; transesterified oils of these liquid oils; transesterified oils of these liquid oils and solid fats; soft oils and flexible oils which are in a fluid state at 30° C. such as palm olein obtained by fractionating solid fats; and hydrogenated oils which are in a fluid state at 30° C. and obtained by hydrogenation of these liquid oils. Additionally, even the oil/fat which is not in a fluid state at 30° C. on its own can be used as a mixed oil/fat, which is in a fluid state at 30° C., by mixing with another oil which is in a fluid state at 30° C. These oils may be used singly or two or more kinds thereof may be used concomitantly.

Among them, medium chain fatty acid triglyceride having a C₆₋₁₀ fatty acid residue; transesterified oils between liquid oils and solid fats; a mixed oil of soybean oil, palm olein, and hydrogenated oil of palm oil; palm olein (iodine value of 60 or more); a transesterified oil between palm oil or palm fractionated oil having an iodine value less than 60 (for example, palm olein having an iodine value of less than 60) and soybean oil; and a mixed oil of palm olein and soybean oil are preferable. In particular, when a transesterified oil between palm fractionated oil having an iodine value less than 60 and soybean oil is used, suitability for producing bread will be more favorable.

Note that in the present invention, the term “liquid oil” refers to an oil/fat which is mobile at 20 to 25° C. and the term “solid fat” refers to an oil/fat which is immobile at 20 to 25° C.

A C₆₋₁₀ fatty acid residue may be either a linear chain or a branched chain and examples thereof include a valeric acid residue, isovaleric acid residue, caproic acid residue, isocaproic acid residue, enanthic acid residue, isoenanthic acid residue, caprylic acid residue, isocaprylic acid residue, pelargonic acid residue, isopelargonic acid residue, capric acid residue, and isocapric acid residue. It may also be one having not only a saturated bond but also an unsaturated bond within its structure. Preferable examples of medium chain fatty acid triglyceride having a C₆₋₁₀ fatty acid residue include a medium chain fatty acid triglyceride which contains about 75 mass % of C₈ fatty acids and about 25 mass % of C₁₀ fatty acids out of total constituting fatty acids.

In addition, preferable examples of the aforementioned solid fats include one, two, or more oils selected from the group consisting of palm oil, fractionated oil of palm oil, highly hydrogenated oil of palm oil, and highly hydrogenated oil of liquid oil. Preferable examples of transesterified oils between liquid oils and solid fats include a transesterified oil between rapeseed oil and palm oil and transesterified oil between soybean oil and palm oil.

Note that the expression “fluid state” used herein refers to a state where an oil/fat readily flows out from a container when the container is tipped and the same applies hereinafter.

The solid fat content of the aforementioned oil/fat, which is in a fluid state at 30° C. and is used in the present invention, at 10° C. is 0 to 30% and preferably 0 to 25% and more preferably 0 to 22%. Additionally, the solid fat content thereof at 25° C. is 0 to 15% and preferably 0 to 10% and more preferably 0 to 7%.

Note that the solid fat content can be measured in accordance with the “Tentative 1-1996 NMR method for solid fat content” in Standard Methods for the Analysis of Fats, Oils and Related Materials.

The content of the oil/fat, which is in a fluid state at 30° C., in an oil/fat composition is preferably 75 to 99 mass %, more preferably 80 to 98 mass %, and even more preferably 85 to 97 mass %.

The content of the solid fat, which is used in the present invention and derived from palm oil and has an iodine value of 0 to 21, in an oil/fat composition is preferably 0.2 to 20 mass %, more preferably 0.4 to 16 mass %, and even more preferably 0.6 to 12 mass %.

In addition, the iodine value of the solid fat, which is derived from palm oil, is preferably 0 to 21, more preferably 0 to 19, and even more preferably 0 to 17.

Examples of the solid fat, which has an iodine value of 0 to 21 and is derived from palm oil, include highly hydrogenated oil of palm oil, highly hydrogenated oil of fractionated palm oil (e.g. highly hydrogenated oil of palm stearin), and palm stearin. Palm stearin is particularly preferable among them since its crystals are finer than those of the others.

When an highly hydrogenated oil of palm oil is used as the solid fat derived from palm oil, the content of the highly hydrogenated oil of palm oil in an oil/fat composition is preferably 0.2 to 20 mass %, more preferably 0.4 to 16 mass %, and even more preferably 0.6 to 12 mass %.

The iodine value of the highly hydrogenated oil of palm oil is preferably 0 to 10 and more preferably 0 to 2.

When palm stearin is used as the solid fat derived from palm oil, the content of palm stearin in an oil/fat composition is preferably 0.2 to 20 mass %, more preferably 0.4 to 16 mass %, and even more preferably 0.6 to 12 mass %.

In addition, the iodine value of palm stearin is preferably 0 to 21, more preferably 0 to 19, and even more preferably 0 to 17.

The content of behenic acid in the fatty acids, which constitute the highly hydrogenated oil of high erucic rapeseed oil used in the present invention, is preferably 30 to 50 mass %, more preferably 35 to 50 mass %, and even more preferably 40 to 50 mass %.

Moreover, since the content of erucic acid in the highly hydrogenated oil of high erucic rapeseed oil is preferably low from a nutritional perspective, the iodine value of the highly hydrogenated oil is preferably 2 or less and more preferably 1 or less.

Furthermore, the content of the highly hydrogenated oil of high erucic rapeseed oil in an oil/fat composition is preferably 0.2 to 20 mass %, more preferably 0.4 to 16 mass %, and even more preferably 0.6 to 12 mass %.

The compounding ratio of the solid fat, which has an iodine value of 0 to 21 and is derived from palm oil, to the highly hydrogenated oil of high erucic rapeseed oil is preferably 95:5 to 20:80, more preferably 95:5 to 50:50, and even more preferably 95:5 to 70:30.

When an highly hydrogenated oil of palm oil is used as the solid fat derived from palm oil, the compounding ratio of the highly hydrogenated oil of high erucic rapeseed oil to the highly hydrogenated oil of palm oil is preferably 20:80 to 80:20, more preferably 30:70 to 70:30, and even more preferably 35:65 to 65:35.

When palm stearin is used as the solid fat derived from palm oil, the compounding ratio of palm stearin to the highly hydrogenated oil of high erucic rapeseed oil is preferably 95:5 to 20:80, more preferably 95:5 to 50:50, and even more preferably 95:5 to 70:30.

Apart from the abovementioned essential components, other materials such as emulsifiers, non-fat dry milk, saccharides, antioxidants, pigments, or flavours which are generally used in the edible oil/fat compositions can be mixed in the oil/fat composition of the present invention where necessary within the range in which the function of the present invention is not impaired.

In order to give satisfactory plasticity to the oil/fat composition, which is used as a spread or a shortening used for kneading, rapid-cooling/mixing is generally carried out in its production process. However, since the oil/fat composition of the present invention uniformly crystallizes and has satisfactory plasticity over a wide temperature range, the rapid-cooling/mixing step can be omitted from its production process. On the other hand, conventionally-known methods can be applied to other steps in the production process. For example, the oil/fat composition of the present invention can be produced by heating/dissolving the oil/fat, which is in a fluid state at 30° C.; solid fat, which has an iodine value of 0 to 21 and is derived from palm oil such as an highly hydrogenated oil of palm oil and palm stearin; and highly hydrogenated oil of high erucic rapeseed oil, at a temperature, which is equal to or above the melting temperature of each of the components, and by mixing them sufficiently.

Since the oil/fat composition of the present invention has plasticity and also does not exhibit solid/liquid separation over a wide temperature range, it can favorably be used for a spread and shortening used for kneading. Moreover, the spread using the oil/fat composition of the present invention can preferably be packaged in a form such as a cup-form and tube-form, and the shortening used for kneading using the oil/fat composition of the present invention can preferably be packaged in a form such as a pillow-packaging form. In addition, a rapid-cooling/mixing step can be omitted in the production process of the spread and shortening used for kneading which uses the oil/fat composition of the present invention. Conventionally-known methods can be applied to other steps in the production process.

The obtained spread has plasticity and also does not exhibit solid/liquid separation over a wide temperature range, and also has favorable melt-in-the-mouth characteristics. Additionally, even when filled in a tube container, the spread can be squeezed out therefrom without any problems.

The obtained shortening used for kneading has plasticity and also does not exhibit solid/liquid separation over a wide temperature range. Additionally, the state and workability of dough are also favorable when the shortening used for kneading is kneaded in bread and confectionery and the textures of the obtained bread and confectionery are also favorable. Examples of the aforementioned confectionery include cookies, biscuits, and shortbread.

Polypropylene or the like can be used as a material for cup containers which are used for packaging the aforementioned spread in a cup-form.

In addition, as a material for tube containers which are used for packaging the aforementioned spread in a tube-form, polyethylene, polyethylene terephthalate, laminated tubes where aluminum is laminated, or the like can be used for the tube-part and polypropylene, rigid polyethylene, or the like can be used for the cap-part.

Moreover, polypropylene or the like can be used as a material for pillow packages which are used for packaging the aforementioned shortening used for kneading in a pillow-packaging form.

### EXAMPLES

The present invention will be described in further detail below based on specific Examples. Note that the present invention is not limited to the content of Examples shown below in any way.

### Oil/Fat Composition Using Medium Chain Fatty Acid Triglyceride as Base Oil

### Example 1 and Comparative Examples 1 and 2

A medium chain fatty acid triglyceride which contains about 75 mass % of C₈ fatty acid and about 25 mass % of C₁₀ fatty acid of the total constituting fatty acids (“ODO” (product name) manufactured by Nisshin OilliO Group, Ltd.); highly hydrogenated oil of palm oil (“highly hydrogenated palm oil” (product name) manufactured by Yokozeki Oil & Fat Corporation and had a melting point of 58° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids) were mixed at loadings shown in Table 1 to obtain oil/fat compositions of Example 1 and Comparative Examples 1 and 2 without carrying out rapid-cooling/mixing. Note that the aforementioned medium chain fatty acid triglyceride used had a solidifying point of −11 to −13° C. and was in a transparent and fluid state at 30° C. Additionally, the solid fat content (hereinafter abbreviated as “SFC”) at 0° C. or more was 0%.

The oil/fat compositions obtained in Example 1 and Comparative Examples 1 and 2 were heated to 60° C. and sample vials (volume: 50 ml) were then filled with 40 g of each oil/fat composition. Thereafter, the state of crystallization after the vials were left to stand and kept at 35° C. for 3 days and the state of the oil/fat compositions after being left to stand and kept at 10° C. for 10 days were observed. Results are shown in Table 1.

TABLE 1

| | | Ex. 1 | Comp. Ex. 1 | Comp. Ex. 2 |
|---|---|---|---|---|
| Loadings in | Medium chain fatty acid | 88 | 88 | 88 |
| oil/fat | triglyceride | | | |
| composition | Highly hydrogenated oil of | 6 | 12 | 0 |
| (mass %) | palm oil | | | |
| | Highly hydrogenated oil of | 6 | 0 | 12 |
| | high erucic rapeseed oil | | | |

| | | | |
|---|---|---|---|
| State of crystallization of oil/fat | Uniform | Solid/liquid | Slight |
| composition after standing at 35° C. for 3 | crystallization | separation | solid/liquid |
| days | | | separation |
| State of oil/fat composition after standing | Satisfactory | | |
| at 10° C. for 10 days | plasticity | | |

As is apparent from Table 1, the oil/fat composition of Example 1 crystallized uniformly after standing (35° C./3 days) and had satisfactory plasticity even after standing (10° C./10 days). Whereas the oil/fat compositions of Comparative Example 1 which did not contain highly hydrogenated oil of high erucic rapeseed oil and of Comparative Example 2 which did not contain highly hydrogenated oil of palm oil exhibited solid/liquid separation after standing (35° C./3 days). Since solid/liquid separation was observed in Comparative Examples 1 and 2, the evaluation after standing (10° C./10 days) was not made.

Although the oil/fat compositions, which contain medium chain fatty acid triglyceride, generally have a tendency to readily exhibit solid/liquid separation, the oil/fat composition of the present invention effectively suppressed the solid/liquid separation of the oil/fat composition even when it contained medium chain fatty acid triglyceride, as is apparent from the results of Example 1. Thus, it was possible to obtain an oil/fat composition which had a favorable quality.

### Oil/fat Composition Having Transesterified Oil as Base Oil

### Example 2

After mixing and dissolving 65 mass parts of palm oil (“Refined palm oil” (product name) manufactured by Nisshin OilliO Group, Ltd.) and 35 mass parts of rapeseed oil (“Refined rapeseed oil” (product name) manufactured by Nisshin OilliO Group, Ltd.), 0.05 mass parts of a lipase preparation (“Lipase PL” (product name) manufactured by Meito Sangyo Co., Ltd.) relative to the mixed oil was added thereto and the resultant was stirred gently at 60° C. to carry out a transesterification reaction. The lipase preparation was removed by filtration 16 hours after the initiation of the reaction to obtain transesterified oil. The obtained transesterified oil was subjected to refining treatments of deoxidation, decolorization, and deodorization following the normal procedures to obtain refined transesterified oil. The refined transesterified oil; highly hydrogenated oil of palm oil (“highly hydrogenated palm oil” (product name) manufactured by Yokozeki Oil & Fat Corporation and had a melting point of 58° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids) were mixed and dissolved at loadings shown in Table 2 to obtain the oil/fat composition of Example 2 without carrying out rapid-cooling/mixing.

### Comparative Example 3

0.05 mass parts of a lipase preparation (“Lipase PL” (product name) manufactured by Meito Sangyo Co., Ltd.) was added relative to 100 mass parts of palm oil (“Refined palm oil” (product name) manufactured by Nisshin OilliO Group, Ltd.) and the resultant was stirred gently at 60° C. to carry out a transesterification reaction. The lipase preparation was removed by filtration 16 hours after the initiation of the reaction to obtain transesterified oil. The obtained transesterified oil was subjected to refining treatments of deoxidation, decolorization, and deodorization following the normal procedures to obtain refined transesterified oil. The refined transesterified oil; highly hydrogenated oil of palm oil (“highly hydrogenated palm oil” (product name) manufactured by Yokozeki Oil & Fat Corporation and had a melting point of 58° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids) were mixed and dissolved at loadings shown in Table 2 to obtain the oil/fat composition of Comparative Example 3 without carrying out rapid-cooling/mixing. Note that SFC of the obtained refined and transesterified oil at respective temperatures is also shown in Table 2.

The oil/fat compositions obtained in Example 2 and Comparative Example 3 were heated to 60° C. and cans for commercial use were then filled with 16 kg of each oil/fat composition. Thereafter, the state of crystallization after the cans were left to stand and kept at 35° C. for 3 days and the state of the oil/fat compositions after being left to stand and kept at 10° C. for 10 days were observed. Results are shown in Table 2.

TABLE 2

| | | Ex. 2 | Comp. Ex. 3 |
|---|---|---|---|
| SFC of refined transesterified oil (%) | 10° C. | 18.1 | 45.9 |
| | 20° C. | 5.4 | 17.9 |
| | 25° C. | 3.4 | 12.8 |
| | 30° C. | 1.5 | 8.9 |

| | | |
|---|---|---|
| State of transesterified oil at 30° C. | Fluid state | Semi-solid state |
| Loadings of refined transesterified oil in oil/fat | 96 | 96 |
| composition (mass %) | | |
| Loadings of highly hydrogenated oil of palm oil in | 2.5 | 2.5 |
| oil/fat composition (mass %) | | |
| Loadings of highly hydrogenated oil of high erucic | 1.5 | 1.5 |
| rapeseed oil in oil/fat composition (mass %) | | |
| State of crystallization of oil/fat composition after | Uniform | Uniform |
| standing at 35° C. for 3 days | crystallization. | crystallization |
| | Creamy state | |
| | without | |
| | separation | |
| State of oil/fat composition after standing at 10° C. for | Satisfactory | Unsatisfactory |
| 10 days | plasticity | plasticity |

As is apparent from Table 2, the refined transesterified oil which was used in Example 2 and which had the SFC at 10° C. and SFC at 25° C. within the range of 0 to 30% and 0 to 15%, respectively, was in a fluid state at 30° C. Further, the oil/fat composition of Example 2 in which highly hydrogenated oil of palm oil and highly hydrogenated oil of high erucic rapeseed oil were mixed, crystallized uniformly in a slow-cooling condition at 35° C., had satisfactory plasticity after standing at 10° C., and could be used over a wide temperature range.

On the other hand, the refined transesterified oil which was used in Comparative Example 3 and which had the SFC at 10° C. that exceeded 30% was in a semi-solid state at 30° C. Further, although the oil/fat composition of Comparative Example 3 in which highly hydrogenated oil of palm oil and highly hydrogenated oil of high erucic rapeseed oil were mixed, crystallized uniformly in a slow-cooling condition at 35° C., it could not be used under low-temperature environments since it hardened after standing at 10° C. and had unsatisfactory plasticity.

### Comparative Examples 4 and 5

In order to verify the necessity of combined use of solid fat derived from palm oil and which has an iodine value of 0 to 21 such as highly hydrogenated oil of palm oil and palm stearin; and highly hydrogenated oil of high erucic rapeseed oil, the following was carried out. Without using solid fat derived from palm oil and which has an iodine value of 0 to 21 such as highly hydrogenated oil of palm oil and palm stearin, the refined transesterified oil using the oil/fat composition of Example 2 as a material; highly hydrogenated oil of rapeseed oil (“highly hydrogenated rapeseed oil” (product name) manufactured by Yokozeki Oil & Fat Corporation and had a melting point of 67° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids) were mixed and dissolved at loadings shown in Table 3 to obtain the oil/fat compositions of Comparative Examples 4 and 5 without carrying out rapid-cooling/mixing.

The oil/fat compositions obtained in Comparative Examples 4 and 5 were heated to 60° C. and cans for commercial use were then filled with 16 kg of each oil/fat composition. Thereafter, the state of the filled oil/fat after being left to stand and kept at 35° C. for 3 days was observed. Results are shown in Table 3.

TABLE 3

| | | Ex. 2 | Comp. Ex. 4 | Comp. Ex. 5 |
|---|---|---|---|---|
| Loadings of | Refined transesterified oil | 96 | 96 | 96 |
| each | Highly hydrogenated oil | 2.5 | 0 | 0 |
| component | of palm oil | | | |
| in oil/fat | Highly hydrogenated oil | 0 | 2.5 | 0 |
| composition | of rapeseed oil | | | |
| (mass %) | Highly hydrogenated oil | 1.5 | 1.5 | 4 |
| | of high erucic rapeseed oil | | | |

| | | | |
|---|---|---|---|
| State of filled oil/fat after oil/fat | No separation. | Solid/liquid | Considerable |
| composition stood at 35° C. for 3 days | Creamy state | separation at | solid/liquid |
| | | upper part. | separation at |
| | | Semi-fluid | upper part. |
| | | state | Semi-fluid |
| | | | state |

As is apparent from Table 3, the oil/fat composition of Example 2, which used an highly hydrogenated oil of high erucic rapeseed oil and highly hydrogenated oil of palm oil concomitantly, did not exhibit solid/liquid separation, solidified altogether uniformly, and could be used as a shortening used for kneading or a base for a spread such as soft chocolate by ladling the content as it is.

On the other hand, the oil/fat composition of Comparative Example 4 which used highly hydrogenated oil of high erucic rapeseed oil and highly hydrogenated oil of rapeseed oil concomitantly had biases in its components although the degree of solid/liquid separation was relatively low, and thus it was difficult to use by ladling the content as it is. The oil/fat composition of Comparative Example 5, in which only highly hydrogenated oil of high erucic rapeseed oil was mixed, exhibited considerable solid/liquid separation.

Accordingly, it was verified that in order to obtain a shortening used for kneading and base for a spread which have favorable properties, it was essential to use the solid fat, which is derived from palm oil and which has an iodine value of 0 to 21 such as highly hydrogenated oil of palm oil and palm stearin, and highly hydrogenated oil of high erucic rapeseed oil concomitantly in oil/fat compositions.

### Oil/Fat Composition Having Soybean Oil, Palm Olein and Hydrogenated Oil of Palm Oil as Base Oil

### Example 3 and Comparative Example 6

The mixed oil of refined soybean oil (“Nisshin refined soybean oil” (product name) manufactured by Nisshin OilliO Group, Ltd.), palm olein (melting point: 21° C.), palm oil (“Refined palm oil” (product name) manufactured by Nisshin OilliO Group, Ltd.), and hydrogenated oil of palm oil (melting point: 47° C.); highly hydrogenated oil of palm oil (“highly hydrogenated palm oil” (product name) manufactured by Yokozeki Oil & Fat Corporation and had a melting point of 58° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids); were mixed at loadings shown in Table 4 to obtain the oil/fat compositions of Example 3 and Comparative Example 6 without carrying out rapid-cooling/mixing. Note that SFC of the mixed oil at respective temperatures in this process is also shown in Table 4.

The oil/fat compositions obtained in Example 3 and Comparative Example 6 were dissolved completely and were packed in a pillow-packaging bag. After heating the pillow-packaging bag and leaving it to stand at 60° C. for 1 hour, the state of the oil/fat composition which stood at 35° C. overnight and the state of the oil/fat composition which stood at 10° C. for 10 days were observed. Results are shown in Table 4.

TABLE 4

| | | Ex. 3 | Comp. Ex. 6 |
|---|---|---|---|
| Composition | Refined soybean oil | 40 | 20 |
| of mixed oil | Palm olein (melting | 50 | — |
| (mass parts) | point: 21° C. | | |
| | Palm oil | — | 70 |
| | Hydrogenated oil of | 4 | 4 |
| | palm oil | | |
| | (melting point: | | |
| | 47° C.) | | |
| SFC of mixed | 10° C. | 21.1 | 36.2 |
| oil (%) | 20° C. | 8.8 | 18.0 |
| | 25° C. | 6.6 | 15.3 |
| | 30° C. | 4.3 | 10.1 |

| | | |
|---|---|---|
| State of mixed oil at 30° C. | Fluid state | Semi-solid state |
| Loadings of mixed oil in oil/fat | 94 | 94 |
| composition (mass %) | | |
| Loadings of highly hydrogenated oil | 3 | 3 |
| of palm oil in oil/fat composition | | |
| (mass %) | | |
| Loadings of highly hydrogenated oil | 3 | 3 |
| of high erucic rapeseed oil in oil/fat | | |
| composition (mass %) | | |
| State of crystallization of oil/fat | Uniform | Uniform |
| composition after standing overnight | crystallization | crystallization |
| at 35° C. | | |
| State of oil/fat composition after | Satisfactory | Unsatisfactory |
| standing at 10° C. for 10 days | plasticity | plasticity |

As is apparent from Table 4, the mixed oil which was used in Example 3 and which had the SFC at 10° C. and SFC at 25° C. within the range of 0 to 30% and 0 to 15%, respectively, was in a fluid state at 30° C. Further, the oil/fat composition of Example 3 and in which highly hydrogenated oil of palm oil and highly hydrogenated oil of high erucic rapeseed oil were mixed, crystallized uniformly in a slow-cooling condition at 35° C., had satisfactory plasticity after standing at 10° C., and could be used over a wide temperature range.

On the other hand, the mixed oil which was used in Comparative Example 6 and which had the SFC at 10° C. and SFC at 25° C. exceeding 30% and 15%, respectively, was in a semi-solid state at 30° C. Further, although the oil/fat composition of Comparative Example 6 in which highly hydrogenated oil of palm oil and highly hydrogenated oil of high erucic rapeseed oil were mixed, crystallized uniformly in a slow-cooling condition at 35° C., it could not be used under low-temperature environments since it hardened after standing at 10° C. and had unsatisfactory plasticity.

### Comparative Examples 7 and 8

In order to verify the necessity of combined use of solid fat derived from palm oil and which has an iodine value of 0 to 21 such as highly hydrogenated oil of palm oil and palm stearin; and highly hydrogenated oil of high erucic rapeseed oil, the following was carried out. The mixed oil using the oil/fat composition of Example 3 as a material (soybean oil, palm olein (melting point: 21° C.), and hydrogenated oil of palm oil (melting point: 47° C.); highly hydrogenated oil of palm oil (“highly hydrogenated palm oil” (product name) manufactured by Yokozeki Oil & Fat Corporation and had a melting point of 58° C.); and highly hydrogenated oil of high erucic rapeseed oil (“highly hydrogenated high erucic rapeseed oil” (product name) manufactured by Yokozeki Oil & Fat Corporation, had a melting point of 60° C., and had a behenic acid content of 45 to 46 mass % of the total constituting fatty acids) were mixed and dissolved at loadings shown in Table 5 to obtain the oil/fat compositions of Comparative Examples 7 and 8 without carrying out rapid-cooling/mixing.

The oil/fat compositions obtained in Comparative Examples 7 and 8 were dissolved completely and 1 kg of each composition was packed in a pillow-packaging bag (volume: 1 kg). After heating the pillow-packaging bag and leaving it to stand at 60° C. for 1 hour, the state of the oil/fat composition which stood at 35° C. overnight was observed at room temperature. Results are shown in Table 5.

In addition, as with the aforementioned oil/fat composition of Example 3, 1 kg of said composition was dissolved completely, packed in a pillow-packaging bag, heated and left to stand at 60° C. for 1 hour, and then left to stand at 35° C. overnight, and thereafter, the state of the oil/fat composition was observed at room temperature. Results are shown in Table 5.

TABLE 5

| | | | | Comp. | Comp. |
|---|---|---|---|---|---|
| | | | Ex. 3 | Ex. 7 | Ex. 8 |
| Loadings | Mixed | Refined | 40 | 40 | 40 |
| of each | oil | soybean oil | | | |
| com- | | Palm olein | 50 | 50 | 50 |
| ponent in | | (melting point: | | | |
| oil/fat | | 21° C.) | | | |
| com- | | Hydrogenated | 4 | 4 | 4 |
| position | | oil of palm oil | | | |
| (mass %) | | (melting point: | | | |
| | | 47° C.) | | | |

| | | | |
|---|---|---|---|
| Highly hydrogenated oil | 3 | 6 | 0 |
| of palm oil | | | |
| Highly hydrogenated oil | 3 | 0 | 6 |
| of high erucic rapeseed | | | |
| oil | | | |

| | | | |
|---|---|---|---|
| State of oil/fat composition at room | Uniform | Overall | Separation |
| temperature | creamy | solid/ | of about |
| | state | liquid | 10% |
| | | separation | liquid |
| | | | portion |

As is apparent from Table 5, the oil/fat composition of Example 3, which used an highly hydrogenated oil of high erucic rapeseed oil and highly hydrogenated oil of palm oil concomitantly, did not exhibit solid/liquid separation, solidified altogether uniformly, and had appropriate solid state properties to be used as a shortening used for kneading or a base for a spread.

On the other hand, the oil/fat composition of Comparative Example 7, in which only highly hydrogenated oil of palm oil was mixed, exhibited considerable solid/liquid separation, and thus had inappropriate properties. In addition, also with the oil/fat composition of Comparative Example 8, in which only highly hydrogenated oil of high erucic rapeseed oil was mixed, partial separation of liquid oil was observed, and thus had inappropriate properties.

Accordingly, it was verified that in order to obtain a shortening used for kneading and base for a spread which have favorable properties, the solid fat which is derived from palm oil and which has an iodine value of 0 to 21 such as highly hydrogenated oil of palm oil and palm stearin, and highly hydrogenated oil of high erucic rapeseed oil were essential components.

### Spread

### Example 4 and Comparative Examples 9 and 10

Spreads were produced by using oil/fat compositions of Example 1 and Comparative Examples 1 and 2 as oil/fat at loadings shown in Table 6 without carrying out rapid-cooling/mixing.

Specifically, powdered sugar, non-fat dry milk, and soy flour which were the solid content apart from the oil/fat were placed in a bowl and after adding one-third of the oil/fat, which was in a dissolved state, and mixing them altogether, the resultant was passed through a roller to grind and to finely powder. The powder obtained by the above fine powdering was collected in a bowl and while the bowl was put in a water bath, the remaining two-thirds of the oil/fat, in which lecithin was dissolved and which was in a dissolved state, was added little by little to the bowl while stirring. The bowl was taken out of the water bath when the entire content was sufficiently mixed and the resulting content was cooled down to 20° C. in an ice-water bath while stirring to obtain the spreads of Example 4 and Comparative Examples 9 and 10.

TABLE 6

| Mixed material | Loadings (mass %) |
|---|---|
| Oil/fat | 44.8 |
| Powdered sugar | 25.0 |
| Soy flour | 20.0 |
| Non-fat dry milk | 10.0 |
| Lecithin | 0.2 |
| Total | 100.0 |

Tube containers were each filled with the obtained spread of Example 4, and Comparative Examples 9 and 10. After storing the tube containers at 20° C. for one week, the state of the spread when squeezed out from the tube containers and melt-in-the-mouth characteristics of the spread were evaluated conforming to the evaluation criteria shown below. Results are shown in Table 7.

### <Evaluation Criteria for Spread>

State of solid/liquid separation:

| | |
|---|---|
| Favorable state without solid/liquid separation | ∘ |
| Exudation of liquid oil on spread surface | Δ |
| Observation of separated liquid oil at the time of squeezing | X |

State of spread when squeezed out from tube:

| | |
|---|---|
| Firm | ∘ |
| Loose | Δ |
| Deformed | X |

Melt-in-the-mouth characteristics:

| | |
|---|---|
| Favorable without any unpleasantness | ∘ |
| Slight unpleasantness remained | Δ |
| Unpleasantness remained, or impossible | x |
| to evaluate due to solid/liquid separation | |

TABLE 7

| | | Ex. 4 | Comp. Ex. 9 | Comp. Ex. 10 |
|---|---|---|---|---|
| Oil/fat composition used | | Ex. 1 | Comp. Ex. 1 | Comp. Ex. 2 |
| Loadings of | Medium chain | 88 | 88 | 88 |
| each | fatty acid | | | |
| component in | triglyceride | | | |
| oil/fat | Highly | 6 | 12 | 0 |
| composition | hydrogenated | | | |
| used (mass %) | oil of palm oil | | | |
| | Highly | 6 | 0 | 12 |
| | hydrogenated | | | |
| | oil of high | | | |
| | erucic rapeseed | | | |
| | oil | | | |

| | | | |
|---|---|---|---|
| State of solid/liquid separation | ∘ | x | Δ |
| State of spread when squeezed out | ∘ | x | Δ |
| from tube | | | |
| Melt-in-the-mouth characteristics | ∘ | x | Δ |

As is apparent from Table 7, the spread of Comparative Example 9, which used the oil/fat composition of Comparative Example 1 in which only highly hydrogenated oil of palm oil was mixed with medium chain fatty acid triglyceride, exhibited considerable solid/liquid separation, and thus was not suitable as a commercial product. In addition, with the spread of Comparative Example 10, which used the oil/fat composition of Comparative Example 2 in which only highly hydrogenated oil of high erucic rapeseed oil was mixed with medium chain fatty acid triglyceride, exudation of liquid portion was observed although retention of spread shape was ensured to some extent. Although it is possible that the extent of exudation may be alleviated by increasing the loadings of highly hydrogenated oil of high erucic rapeseed oil, the spread of Comparative Example 10 already had unpleasant melt-in-the-mouth characteristics, and thus increasing of the loadings is difficult.

On the other hand, with the spread of Example 4, which used the oil/fat composition of Example 1 in which highly hydrogenated oil of palm oil and highly hydrogenated oil of high erucic rapeseed oil were used concomitantly at a ratio of 50:50, the problem of solid/liquid separation was improved dramatically, the state of the spread when squeezed out from the tube was firm, and unpleasantness in terms of melt-in-the-mouth characteristics due to highly hydrogenated oil was also absent, and thus it was preferable compared to the cases where highly hydrogenated oil of palm oil or highly hydrogenated oil of high erucic rapeseed oil was used alone. In other words, in order to obtain spreads having desirable properties, it was verified that the combined use of the solid fat which was derived from palm oil and which had an iodine value of 0 to 21 such as highly hydrogenated oil of palm oil and palm stearin, and highly hydrogenated oil of high erucic rapeseed oil in oil/fat compositions was essential.

### Shortening Used for Kneading

### Example 5

By using the oil/fat composition of Example 3 as shortening for kneading (Example 5), bread was produced by the 70% sponge-dough method (2.5 hours of sponge fermentation) at loadings shown in Table 8. As a Reference Example, by using a commercially available shortening (Toremo 10Z (product name) manufactured by Nisshin OilliO Group, Ltd.) which was produced by carrying out rapid-cooling/mixing, bread was similarly produced by the 70% sponge-dough method (2.5 hours of sponge fermentation) at loadings shown in Table 8.

TABLE 8

| | Sponge | In kneading step |
|---|---|---|
| | (mass parts) | (mass parts) |
| Oil/fat | — | 6.0 |
| Strong flour | 70.0 | 30.0 |
| Yeast | 2.5 | — |
| Yeast food | 0.1 | — |
| Water | 40.0 | 26.0 |
| White superior soft sugar | — | 6.0 |
| Salt | — | 1.7 |
| Non-fat dry milk | — | 3.0 |

Suitability for producing bread was evaluated by evaluating the state and workability of dough and the texture of obtained bread when producing bread using the shortening of Example 5 for kneading and commercially available shortening. Results are shown in Table 9.

TABLE 9

| | Ex. 5 | Ref. Ex. |
|---|---|---|
| Oil/fat composition used | Ex. 3 | Commercially available shortening |
| State of dough | Favorable | Favorable |
| Workability of dough | Favorable | Favorable |
| Bread texture | Favorable | Favorable |

As is apparent from Table 9, the bread which was produced by using the shortening of Example 5 for kneading without carrying out rapid-cooling/mixing had a favorable dough state, dough workability, and bread texture, and thus the shortening used for kneading showed equivalent suitability for producing bread to that of the commercially available shortening, which was produced by carrying out rapid-cooling/mixing.

### Oil/Fat Composition Containing Palm Olein, Palm Stearin or Highly Hydrogenated Oil of Palm Oil, and Highly Hydrogenated Oil of High Erucie Rapeseed Oil

### Examples 6 and 7 and Comparative Examples 111 to 16

Oil/fat compositions of Examples 6 and 7 and Comparative Examples 11 to 16 were obtained using the following oil/fats and mixing them at loadings shown in Table 10 without carrying out rapid-cooling/mixing. The oil/fats were palm olein (manufactured by Intercontinental Speciality Fats Sdn. Bhd., Malaysia which had an iodine value of 65 and SFC of 0.7%, 0.2%, 0%, and 0% at 10° C., 20° C., 25° C., and 30° C., respectively); highly hydrogenated oil of cottonseed oil (prepared in a laboratory and had an iodine value of 1); highly hydrogenated oil of palm oil (“highly hydrogenated palm oil” (product name) manufactured by Yokozeki Oil & Fat Corporation and had a melting point of 58° C. and iodine value of 2 or less); highly hydrogenated oil of rapeseed oil (“highly hydrogenated rapeseed oil” (product name) manufactured by Yokozeki Oil & Fat Corporation and had a melting point of 67° C.); palm stearin (manufactured by Intercontinental Speciality Fats Sdn. Bhd., Malaysia and had an iodine value of 12); and highly hydrogenated oil of high erucic rapeseed oil (“highly hydrogenated high erucic rapeseed oil” (product name) manufactured by Yokozeki Oil & Fat Corporation, had a melting point of 60° C., a behenic acid content of 45 to 46 mass % of the total constituting fatty acids, and iodine value of 2 or less).

100 g of the oil/fat compositions obtained in Examples 6 and 7 and Comparative Examples 11 to 16 were each collected in a 200-ml beaker and after dissolving the crystals of oil/fat compositions completely at 70° C., the state of crystallization after the oil/fat compositions were left to stand and kept at 35° C. overnight and the state of the oil/fat compositions after being left to stand and kept at 10° C. for 10 days were observed. Results are shown in Table 10.

TABLE 10

| | | Comp. | Comp. Ex. | Comp. | Comp. | Comp. Ex. | | Comp. | |
|---|---|---|---|---|---|---|---|---|---|
| | | Ex. 11 | 12 | Ex. 13 | Ex. 14 | 15 | Ex. 6 | Ex. 16 | Ex. 7 |
| Loadings | Palm olein | 90 | 90 | 90 | 90 | 90 | 90 | 90 | 90 |
| in oil/fat | Highly | 10 | 8 | 0 | 0 | 0 | 0 | 0 | 0 |
| com- | hydrogenated oil | | | | | | | | |
| position | of cottonseed oil | | | | | | | | |
| (mass %) | Highly | 0 | 0 | 10 | 8 | 0 | 0 | 0 | 0 |
| | hydrogenated oil | | | | | | | | |
| | of rapeseed oil | | | | | | | | |
| | Highly | 0 | 0 | 0 | 0 | 10 | 8 | 0 | 0 |
| | hydrogenated oil | | | | | | | | |
| | of palm oil | | | | | | | | |
| | Palm stearin | 0 | 0 | 0 | 0 | 0 | 0 | 10 | 8 |
| | Highly | 0 | 2 | 0 | 2 | 0 | 2 | 0 | 2 |
| | hydrogenated oil | | | | | | | | |
| | of high erucic | | | | | | | | |
| | rapeseed oil | | | | | | | | |

| | | | | | | | | |
|---|---|---|---|---|---|---|---|---|
| State of crystallization of oil/ | Exudation | Fluid | Solid/liquid | Exudation | Solid/liquid | Uniform | Virtually | Uniform |
| fat composition after standing | of liquid | state. | separation | of liquid | separation | crystallization | liquid | crystalliza- |
| overnight at 35° C. | oil | Exudation | | oil | | | | tion. |
| | | of liquid | | | | | | Fine and |
| | | oil | | | | | | favorable |
| | | | | | | | | crystals |
| State of oil/fat composition | | | | | | Satisfactory | | Satisfactory |
| after standing at 10° C. for 10 | | | | | | plasticity | | plasticity. |
| days | | | | | | | | Extremely |
| | | | | | | | | favorable |

As is apparent from Table 10, the oil/fat compositions of Example 6 containing highly hydrogenated oil of palm oil and of Example 7, in which palm stearin was mixed, crystallized uniformly after being left to stand at 35° C. overnight and had satisfactory plasticity even after being left to stand at 10° C. for 10 days. Both highly hydrogenated oil of palm oil in Example 6 and palm stearin in Example 7 were the solid fat derived from palm oil and had an iodine value of 0 to 21. In addition, when the quality of the oil/fat composition of Example 6, in which highly hydrogenated oil of palm oil was mixed, was compared to that of the oil/fat composition of Example 7, in which palm stearin was mixed, the oil/fat composition of Example 7, in which palm stearin was mixed, had finer crystals after being left to stand at 35° C. overnight and also better plasticity, and thus had more favorable quality.

On the other hand, the oil/fat compositions of Comparative Examples 11 to 16 which did not contain the solid fat which was derived from palm oil and which had an iodine value of 0 to 21 such as highly hydrogenated oil of palm oil and palm stearin had an unsatisfactory crystallization state after being left to stand at 35° C. overnight. Note that with Comparative Examples 11 to 16, since properties thereof were liquid, or exudation of liquid oil or solid/liquid separation was observed after being left to stand at 35° C. overnight, evaluation after standing at 10° C. for 10 days was not made.

### Oil/Fat Composition Containing Transesterified Oil Between Palm Olein and Soybean Oil, Palm Stearin or Highly Hydrogenated Oil of Palm Oil, and Highly Hydrogenated Oil of High Erucic Rapeseed Oil

### Examples 8 and 9 and Comparative Examples 17 to 21

After mixing and dissolving 60 mass parts of palm olein (“Palm olein” (product name) manufactured by Nisshin OilliO Group, Ltd. and had an iodine value of 56) and 40 mass parts of soybean oil (“Refined soybean oil” (product name) manufactured by Nisshin OilliO Group, Ltd.), 0.05 mass parts of a lipase preparation (“Lipase PL” (product name) manufactured by Meito Sangyo Co., Ltd.) relative to the mixed oil was added thereto and the resultant was stirred gently at 60° C. to carry out a transesterification reaction. The lipase preparation was removed by filtration 16 hours after the initiation of the reaction to obtain transesterified oil I. The obtained transesterified oil I was subjected to refining treatments of deoxidation, decolorization, and deodorization following the normal procedures to obtain refined transesterified oil I. SFC of the obtained refined transesterified oil I was 11.4%, 3.8%, 1.7%, and 0.6% at 10° C., 20° C., 25° C., and 30° C., respectively.

The refined transesterified oil I; highly hydrogenated oil of cottonseed stearin (prepared in a laboratory and had an iodine value of 1); highly hydrogenated oil of palm oil (“highly hydrogenated palm oil” (product name) manufactured by Yokozeki Oil & Fat Corporation and had a melting point of 58° C. and iodine value of 2 or less); palm stearin (manufactured by Intercontinental Speciality Fats Sdn. Bhd., Malaysia and had an iodine value of 12); and highly hydrogenated oil of high erucic rapeseed oil (“highly hydrogenated high erucic rapeseed oil” (product name) manufactured by Yokozeki Oil & Fat Corporation and had a melting point of 60° C., a behenic acid content of 45 to 46 mass % of the total constituting fatty acids, and iodine value of 2 or less) were used and they were mixed at loadings shown in Table 11 to obtain the oil/fat compositions of Examples 8 and 9 and Comparative Examples 17 to 21 without carrying out rapid-cooling/mixing.

100 g of the oil/fat compositions obtained in Examples 8 and 9 and Comparative Examples 17 to 21 were each collected in a 200-ml beaker and after dissolving the crystals of oil/fat compositions completely at 70° C., the state of crystallization after the oil/fat compositions were left to stand at 35° C. overnight and the state of the oil/fat compositions after being left to stand and kept at 10° C. for 10 days were observed.

Results are shown in Table 11.

TABLE 11

| | | Comp. Ex. | Comp. Ex. | Comp. Ex. | | Comp. Ex. | | |
|---|---|---|---|---|---|---|---|---|
| | | 17 | 18 | 19 | Ex. 8 | 20 | Ex. 9 | Comp. Ex. 21 |
| Loadings in | Refined | 90 | 90 | 90 | 90 | 90 | 90 | 90 |
| oil/fat | transesterified oil I | | | | | | | |
| composition | Highly | 10 | 8 | 0 | 0 | 0 | 0 | 0 |
| (mass %) | hydrogenated oil of | | | | | | | |
| | cottonseed stearin | | | | | | | |
| | Highly | 0 | 0 | 10 | 8 | 0 | 0 | 0 |
| | hydrogenated oil of | | | | | | | |
| | palm oil | | | | | | | |
| | Palm stearin | 0 | 0 | 0 | 0 | 10 | 8 | 0 |
| | Highly | 0 | 2 | 0 | 2 | 0 | 2 | 10 |
| | hydrogenated oil of | | | | | | | |
| | high erucic rapeseed | | | | | | | |
| | oil | | | | | | | |

| | | | | | | | |
|---|---|---|---|---|---|---|---|
| State of crystallization of oil/fat | Solid/liquid | Solid/liquid | Solid/liquid | Uniform | Virtually | Uniform | Uniform |
| composition after standing | separation | separation | separation | crystalliza- | liquid | crystallization. | crystallization |
| overnight at 35° C. | | | | tion | | Fine and | although |
| | | | | | | favorable | somewhat in |
| | | | | | | crystals | fluid state |
| State of oil/fat composition after | | | | Satisfactory | | Satisfactory | Somewhat soft. |
| standing at 10° C. for 10 days | | | | plasticity | | plasticity. | Unsatisfactory |
| | | | | | | Extremely | plasticity |
| | | | | | | favorable | |

As is apparent from Table 11, the oil/fat compositions of Example 8 containing highly hydrogenated oil of palm oil and of Example 9, in which palm stearin was mixed, crystallized uniformly after being left to stand at 35° C. overnight and had satisfactory plasticity even after being left to stand at 10° C. for 10 days. Both highly hydrogenated oil of palm oil in Example 8 and palm stearin in Example 9 were the solid fat derived from palm oil and had an iodine value of 0 to 21. In addition, when the quality of the oil/fat composition of Example 8, in which highly hydrogenated oil of palm oil was mixed, was compared to that of the oil/fat composition of Example 9, in which palm stearin was mixed, the oil/fat composition of Example 9, in which palm stearin was mixed, had finer crystals after being left to stand at 35° C. overnight and also better plasticity, and thus had more favorable quality.

On the other hand, the oil/fat compositions of Comparative Examples 17, 18, and 21 which did not contain the solid fat which was derived from palm oil and which had an iodine value of 0 to 21 such as highly hydrogenated oil of palm oil and palm stearin; and oil/fat compositions of Comparative Examples 19 and 20 which did not contain highly hydrogenated oil of high erucic rapeseed oil had an unsatisfactory crystallization state and plasticity after being left to stand at 35° C. overnight. Note that with Comparative Examples 17 to 20, since properties thereof were liquid or since solid/liquid separation was observed after being left to stand at 35° C. overnight, evaluation after standing at 10° C. for 10 days was not made. Shortening used for kneading

### Examples 10 to 17 and Comparative Examples 22 and 23

After mixing and dissolving 50 mass parts of palm olein (“Palm olein” (product name) manufactured by Nisshin OilliO Group, Ltd. and had an iodine value of 56) and 50 mass parts of soybean oil (“Refined soybean oil” (product name) manufactured by Nisshin OilliO Group, Ltd.), 0.05 mass parts of a lipase preparation (“Lipase PL” (product name) manufactured by Meito Sangyo Co., Ltd.) relative to the mixed oil was added thereto and the resultant was stirred gently at 60° C. to carry out a transesterification reaction. The lipase preparation was removed by filtration 16 hours after the initiation of the reaction to obtain transesterified oil II. The obtained transesterified oil II was subjected to refining treatments of deoxidation, decolorization, and deodorization following the normal procedures to obtain refined transesterified oil II. SFC of the obtained refined transesterified oil II was 8.3%, 3.2%, 0.5%, and 0% at 10° C., 20° C., 25° C., and 30° C., respectively. In addition, refined transesterified oil III was obtained by carrying out the same transesterification reaction and refining treatments as those of refined transesterified oil II except that the mixing ratio of palm olein and soybean oil was 80 mass parts and 20 mass parts, respectively. SFC of the obtained refined transesterified oil III was 19.8%, 4.2%, 2.2%, and 1.1% at 10° C., 20° C., 25° C., and 30° C., respectively.

The aforementioned refined transesterified oil II; aforementioned refined transesterified oil III; palm olein I (manufactured by Intercontinental Speciality Fats Sdn. Bhd., Malaysia which had an iodine value of 65); palm olein II (“Palm olein” (product name) manufactured by Nisshin OilliO Group, Ltd. and had an iodine value of 56); soybean oil (“Refined soybean oil” (product name) manufactured by Nisshin OilliO Group, Ltd.); palm stearin (manufactured by Intercontinental Speciality Fats Sdn. Bhd., Malaysia which had an iodine value of 16); and highly hydrogenated oil of high erucic rapeseed oil (“highly hydrogenated high erucic rapeseed oil” (product name) manufactured by Yokozeki Oil & Fat Corporation, had a melting point of 60° C., had a behenic acid content of 45 to 46 mass % of the total constituting fatty acids, and had an iodine value of 2 or less) were used and they were mixed at loadings shown in Table 12 to obtain the oil/fat compositions of Examples 10 to 13 and Comparative Example 22 without carrying out rapid-cooling/mixing.

100 g of the oil/fat compositions obtained in Examples 10 to 13 and Comparative Example 22 were each collected in a 200-ml beaker and after dissolving the crystals of oil/fat compositions completely at 70° C., the state of crystallization after the oil/fat compositions were left to stand at 35° C. overnight and the state of the oil/fat compositions after being left to stand and kept at 10° C. for 10 days were observed. Results are shown in Table 12.

TABLE 12

| | | Ex. 10 | Ex. 11 | Ex. 12 | Ex. 13 | Comp. Ex. 22 |
|---|---|---|---|---|---|---|
| Loadings in | Palm olein I | 88 | 0 | 0 | 0 | 0 |
| oil/fat | Palm olein II | 0 | 44 | 0 | 0 | 0 |
| composition | Soybean oil | 0 | 44 | 0 | 0 | 0 |
| (mass %) | Transesterified oil II | 0 | 0 | 88 | 0 | 0 |
| | Transesterified oil III | 0 | 0 | 0 | 88 | 88 |
| | Palm stearin | 11 | 11 | 11 | 11 | 0 |
| | Highly hydrogenated | 1 | 1 | 1 | 1 | 12 |
| | oil of high erucic | | | | | |
| | rapeseed oil | | | | | |

| | | | | | |
|---|---|---|---|---|---|
| State of crystallization of oil/fat | Uniform | Uniform | Uniform | Uniform | Uniform |
| composition after standing overnight | crystallization. | crystallization. | crystallization. | crystallization. | crystallization |
| at 35° C. | Fine and | Fine and | Fine and | Fine and | although somewhat |
| | favorable crystals | favorable crystals | favorable crystals | favorable crystals | in fluid state |
| State of oil/fat composition after | Satisfactory | Satisfactory | Satisfactory | Satisfactory | Satisfactory |
| standing at 10° C. for 10 days | plasticity. | plasticity. | plasticity. | plasticity. | plasticity. |
| | Extremely | Extremely | Extremely | Extremely | |
| | favorable | favorable | favorable | favorable | |

As is apparent from Table 12, the oil/fat compositions of Examples 10 to 13 containing palm stearin, which was the solid fat derived from palm oil and had an iodine value of 0 to 21, crystallized uniformly after being left to stand at 35° C. overnight and had satisfactory plasticity even after being left to stand at 10° C. for 10 days.

On the other hand, the oil/fat composition of Comparative Example 22 which did not contain the solid fat which was derived from palm oil and which had an iodine value of 0 to 21 had an unsatisfactory crystallization state after being left to stand at 35° C. overnight.

By using the oil/fat compositions of Examples 10 to 13 and Comparative Example 22 as shortening for kneading, bread of Examples 14 to 17 and Comparative Example 23 was produced by the 70% sponge-dough method (2.5 hours of sponge fermentation) at the same loadings as those shown in Table 8.

Suitability for producing bread was evaluated by evaluating the state and workability of dough and the texture of obtained bread when producing bread. Results are shown in Table 13.

TABLE 13

| | | | | | Comp. Ex. |
|---|---|---|---|---|---|
| | Ex. 14 | Ex. 15 | Ex. 16 | Ex. 17 | 23 |
| Oil/fat | Ex. 10 | Ex. 11 | Ex. 12 | Ex. 13 | Comp. Ex. |
| composition | | | | | 22 |
| used | | | | | |
| State of | Highly | Favorable | Favorable | Highly | Somewhat |
| dough | favorable | | | favorable | hard |
| Workability | Favorable | Favorable | Highly | Highly | Difficult |
| of dough | | | favorable | favorable | to extend |
| Bread | Favorable | Favorable | Highly | Highly | Hard |
| texture | | | favorable | favorable | |

As is apparent from Table 13, the bread of Examples 14 to 17 which was produced by using the shortening of Examples 10 to 13 for kneading had a favorable dough state, dough workability, and bread texture. Especially, shortening of Examples 12 and 13 for kneading which used the oil/fat that was obtained by transesterifying the mixed oil of palm olein and soybean oil as a base showed particularly excellent suitability for producing bread.

On the other hand, the bread which used the shortening of Comparative Example 22, which did not contain palm stearin as the solid fat derived from palm oil and had an iodine value of 0 to 21, hardened and did not have a favorable texture.

From the results so far, it was verified that the oil/fat composition of the present invention exhibited suppression of solid/liquid separation and satisfactory plasticity at the same time without carrying out rapid-cooling/mixing during the production process thereof, and the spread using said oil/fat composition also did not exhibit solid/liquid separation and had favorable melt-in-the-mouth characteristics as well as a favorable spread state when squeezed out from a tube.

In addition, it was verified that the dough using the shortening for kneading obtained from said oil/fat composition showed a favorable state and workability, and the bread produced therefrom also had a favorable texture and had an equivalent quality to the bread using a commercially available shortening, to which rapid-cooling/mixing was carried out.

On the other hand, since it was not necessary to carry out rapid-cooling/mixing for said oil/fat composition, it was verified that in the production thereof, cost reduction can be achieved due to the simplification of process.

### INDUSTRIAL APPLICABILITY

According to the present invention, an oil/fat composition which does not exhibit solid/liquid separation and which has satisfactory plasticity over a wide temperature range is obtained, and a spread and shortening used for kneading which have favorable properties are obtained using said oil/fat composition. Bread or confectionery which has a favorable texture can be produced from them. Additionally, since rapid-cooling/mixing is not required at the time of their production, cost reduction is possible and can be widely used in the food industry.

1. An oil/fat composition comprising:
an oil/fat which is in a fluid state at 30° C.;
solid fat derived from palm oil and which has an iodine value of 0 to 21; and
highly hydrogenated oil of high erucic rapeseed oil;
wherein a solid fat content of the oil/fat, which is in a fluid state at 30° C., at 110° C. is 0 to 30% and also the solid fat content thereof at 25° C. is 0 to 15%.

2. The oil/fat composition according to claim 1,
wherein the composition comprises
75 to 99 mass % of the oil/fat which is in a fluid state at 30° C.;
0.2 to 20 mass % of the solid fat derived from palm oil and which has an iodine value of 0 to 21; and
0.2 to 20 mass % of the highly hydrogenated oil of high erucic rapeseed oil; and
the mass ratio between the solid fat which is derived from palm oil and which has an iodine value of 0 to 21, and highly hydrogenated oil of high erucic rapeseed oil is 95:5 to 20:80.

3. The oil/fat composition according to claim 1, wherein the oil/fat, which is in a fluid state at 30° C., is a medium chain fatty acid triglyceride having a C₆₋₁₀ fatty acid residue.

4. The oil/fat composition according to claim 1, wherein the oil/fat, which is in a fluid state at 30° C., is a transesterification oil between liquid oil and solid fat.

5. The oil/fat composition according to claim 4, wherein the solid fat is one, two, or more oils selected from the group consisting of palm oil, fractionated oil of palm oil, highly hydrogenated oil of palm oil, and highly hydrogenated oil of liquid oil.

6. The oil/fat composition according to claim 1, wherein the oil/fat, which is in a fluid state at 30° C., is a mixed oil of soybean oil, palm olein, and hydrogenated oil of palm oil.

7. The oil/fat composition according to claim 1, wherein the solid fat, which is derived from palm oil and which has an iodine value of 0 to 21, is highly hydrogenated oil of palm oil or palm stearin.

8. (canceled)

9. A spread using an oil/fat composition according to claim 1.

10. (canceled)

11. A shortening used for kneading using an oil/fat composition according to claim 1.

12. (canceled)

13. (canceled)

14. (canceled)

15. A production method of a spread comprising using an oil/fat composition according to claim 1, wherein rapid-cooling/mixing is not carried out.

16. A production method of a shortening used for kneading comprising using an oil/fat composition according to claim 1, wherein rapid-cooling/mixing is not carried out.
